(19) United States
(12) Patent Application Publication
(10) Pub. No.: US 2013/0124190 A1
(43) Pub. Date: May 16, 2013

(54) SYSTEM AND METHODOLOGY THAT FACILITATES PROCESSING A LINGUISTIC INPUT

(71) Applicant: Stephanie Esla, Bakersfield, CA (US)

(72) Inventor: Stephanie Esla, Bakersfield, CA (US)

(21) Appl. No.: 13/295,041

(22) Filed: Nov. 12, 2011

(51) Int. Cl. G06F 17/27

(52) U.S. Cl. 704/9; 704/E11.001

(57) ABSTRACT

Aspects for teaching processing linguistic expressions are disclosed, which include apparatuses, methods, and computer-readable storage media to facilitate such processing. In a particular aspect, modifying a linguistic expression includes receiving an input that includes the linguistic expression and a selection of a target vernacular, and retrieving a phonetic scheme corresponding to the target vernacular, which includes a set of accentuation rules associated with the target vernacular. An audible equivalent of the linguistic expression is then generated in the target vernacular according to the phonetic scheme. In another aspect, phonetic schemes are generated by aggregating linguistic information corresponding to a plurality of vernaculars, and analyzing the linguistic information to ascertain a plurality of accentuation rules. A phonetic scheme is then generated for each of the plurality of vernaculars, which includes a set of accentuation rules associated with the corresponding vernacular.

### TECHNICAL FIELD

The subject disclosure generally relates to processing a linguistic input, and more specifically to a system and methodology that facilitates identifying and modifying a linguistic input.

### BACKGROUND

By way of background concerning conventional linguistic-related tools, it is noted that such tools are primarily directed towards defining/translating linguistic inputs. For instance, an electronic dictionary may be used to define an unfamiliar word, wherein such word may be expressed in a native or foreign language. Most languages, however, are spoken in a wide array of dialects such that the meaning of a particular word may vary according to dialect. Distinguishing between formal and informal meanings within dialects adds a further layer of complexity.

Other linguistic-related tools are also available. For instance, speech recognition software exists, which allows users to dictate and have their speech transcribed as written text. However, when utilizing such software, audible nuances of the user are not captured. For example, such software has no way of transcribing a user's cadence, accent, and/or any other audible nuance.

Accordingly, it would be desirable to provide a device and methodology which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with processing a linguistic input. In one such aspect, a computer-readable storage medium that facilitates modifying a linguistic expression is provided. For this embodiment, the computer-readable storage medium includes computer-readable instructions for causing at least one processor to perform various acts. Such acts comprise receiving an input that includes a linguistic expression and a selection of at least one target vernacular. The acts further comprise retrieving a phonetic scheme corresponding to the at least one target vernacular in which the phonetic scheme includes a set of accentuation rules associated with the at least one target vernacular. An audible equivalent of the linguistic expression is then generated in the at least one target vernacular according to the phonetic scheme.

In another aspect, a system that facilitates modifying a linguistic expression is provided. Within such embodiment, the system includes a processor configured to execute computer executable components stored in memory. The computer executable components include an input component, a scheme component, a generation component, and an output component. The input component is configured to receive an input that includes a linguistic expression and a selection of at least one target vernacular, whereas the scheme component is configured to retrieve a phonetic scheme corresponding to the at least one target vernacular that includes a set of accentuation rules associated with the at least one target vernacular. For this embodiment, the generation component is configured to generate an audible equivalent of the linguistic expression in the at least one target vernacular according to the phonetic scheme. The output component is then configured to output the audible equivalent.

In a further aspect, a method that facilitates generating phonetic schemes is provided. The method includes aggregating linguistic information corresponding to a plurality of vernaculars, and analyzing the linguistic information to ascertain a plurality of accentuation rules. The method further includes generating a plurality of phonetic schemes respectively corresponding to the plurality of vernaculars. Within such embodiment, each of the plurality of phonetic schemes is unique to a particular vernacular and includes a corresponding set of accentuation rules associated with the particular vernacular.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates modifying a linguistic expression in accordance with an aspect of the subject specification;

FIG. 2 illustrates a block diagram of an exemplary linguistic modification unit that facilitates modifying a linguistic expression in accordance with an aspect of the subject specification;

FIG. 3 illustrates an exemplary coupling of electrical components that effectuate modifying a linguistic expression according to an embodiment;

FIG. 4 illustrates a flow diagram of an exemplary methodology for modifying a linguistic expression in accordance with an aspect of the subject specification;

FIG. 5 illustrates a block diagram of an exemplary scheme generation unit that facilitates generating phonetic schemes in accordance with an aspect of the subject specification;

FIG. 6 illustrates an exemplary node hierarchy that facilitates generating phonetic schemes according to an embodiment;

FIG. 7 illustrates an exemplary coupling of electrical components that effectuate generating phonetic schemes according to an embodiment;

FIG. 8 illustrates a block diagram of an exemplary accent determination unit that facilitates identifying vernaculars in accordance with an aspect of the subject specification;

FIG. 9 is a block diagram representing exemplary non-limiting networked environments in which various embodiments described herein can be implemented; and

FIG. 10 is a block diagram representing an exemplary non-limiting computing system or operating environment in which one or more aspects of various embodiments described herein can be implemented.

### DETAILED DESCRIPTION

### Overview

As discussed in the background, conventional linguistic-related tools fail to capture the dialect-specific nuances that exist in many languages. The various embodiments disclosed herein are directed towards capturing such nuances and generating audible equivalents for linguistic expressions input by a user according to these nuances. For instance, embodiments are disclosed that encompass modifying a user's voice according to a desired accent (e.g., modifying a user's voice to emulate a southern accent, a Jamaican accent, a French accent, etc.). In another embodiment, rather than modifying a user's actual voice, an audible equivalent of the user's linguistic input is output in a generic voice having the desired accent. For example, a user may provide a textual input, wherein a generic voice would then read the textual input aloud according to a desired accent.

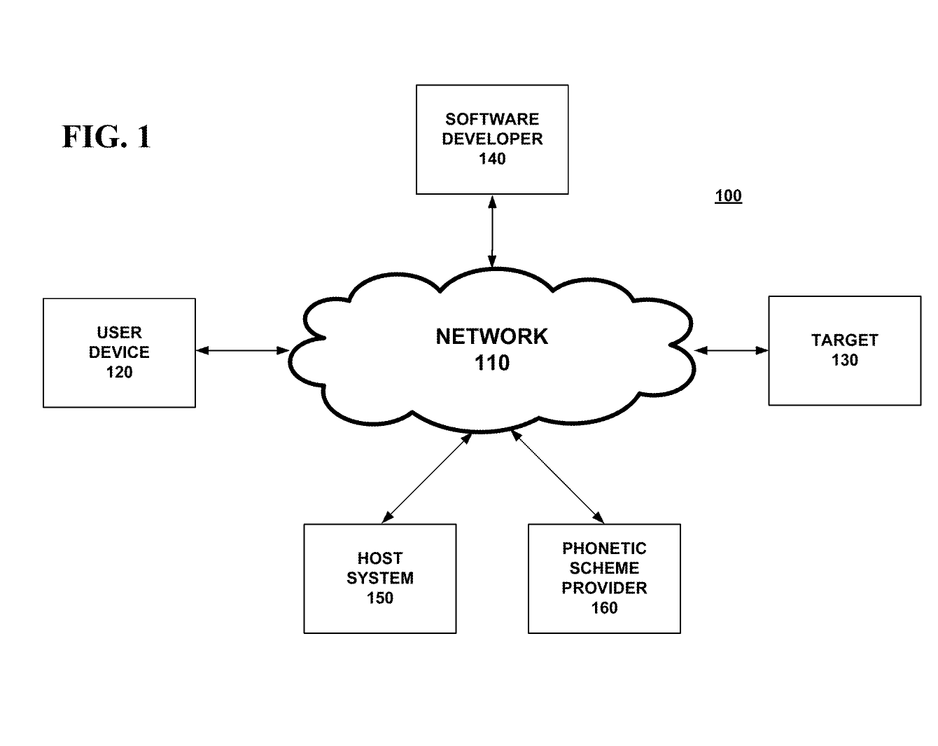

Turning now to FIG. 1, an exemplary environment that facilitates modifying a linguistic expression in accordance with an aspect of the subject specification is provided. As used herein, a “linguistic expression” is defined to be any textual, audio, and/or symbolic communication. As illustrated, environment 100 includes user device 120, which is coupled to target 130, software developer 140, host system 150, and phonetic scheme provider 160 via network 110. In one aspect, user device 120 is configured to receive a linguistic expression and desired vernacular from a user, wherein the linguistic expression is then modified according to the selected vernacular. Here, it should be noted that user device 120 can be any computing device configured to receive an input from a user (e.g., a mobile device, personal computer, etc.). It should also be noted that user device 120 may be further configured to process the modification of the linguistic expression, and/or to coordinate such modification with any combination of target 130, software developer 140, host system 150, and/or phonetic scheme provider 160 via network 110. For instance, it is contemplated that software developed by software developer 140 can be downloaded onto any combination of user device 120, target 130, host system 150, and/or phonetic scheme provider 140 via network 110 to facilitate modifying a user's linguistic expression as desired.

In an exemplary embodiment, software developed by software developer 140 is downloaded onto user device 120, wherein aspects of the modification process are performed on user device 120. For instance, user device 120 may be configured to retrieve a phonetic scheme (e.g., accentuation rules, cadences, etc.) corresponding to the user's selected vernacular (e.g., phonetic scheme for Jamaicans, Germans, French, etc.), wherein the phonetic scheme may be retrieved from phonetic scheme provider 140 and/or within user device 120. User device 120 may then be further configured to generate a modification of the user's linguistic expression according to the retrieved phonetic scheme, and subsequently output the modification to the user and/or target 130. Here, it should be noted that target 130 can be any of a plurality of locations/devices (a mobile device, personal computer, e-mail account, social media site, etc.) configured to receive the modified linguistic expression in any of various forms (e.g., hyperlink, mp3, wave file, etc.).

In another embodiment, however, it is contemplated that aspects of the modification process are performed by host system 150. For instance, host system 150 may be configured to receive the linguistic expression and desired vernacular selection from user device 120, and subsequently perform the modification accordingly. Namely, host system 150 may be configured to retrieve the phonetic scheme corresponding to the user's selected vernacular (e.g., phonetic scheme for Jamaicans, Germans, French, etc.), wherein the phonetic scheme may be retrieved from phonetic scheme provider 140 and/or within host system 150. Host system 150 may then be further configured to generate the modification of the user's linguistic expression according to the retrieved phonetic scheme, and subsequently output the modification to user device 120 and/or target 130.

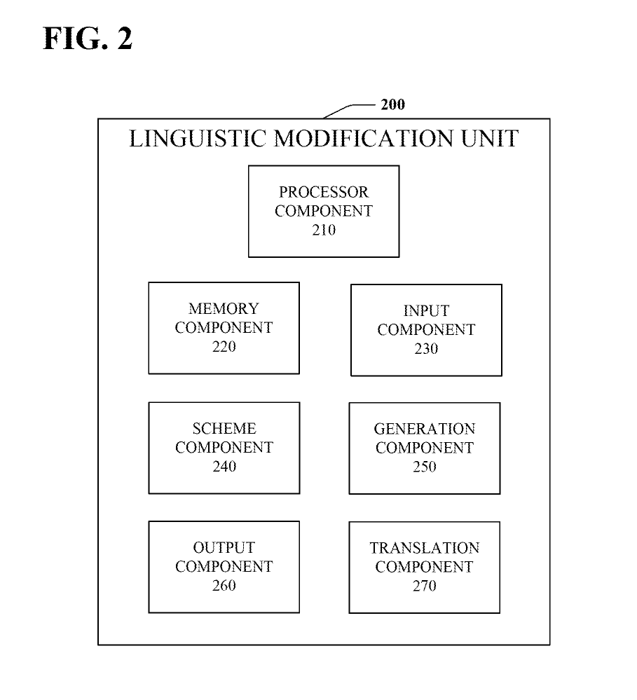

Referring next to FIG. 2, a block diagram of an exemplary linguistic modification unit that facilitates modifying a linguistic expression according to an embodiment is illustrated. As shown, linguistic modification unit 200 may include processor component 210, memory component 220, input component 230, scheme component 240, generation component 250, output component 260, and translation component 270. Here, it should be noted that processor component 210, memory component 220, input component 230, scheme component 240, generation component 250, output component 260, and/or translation component 270 can reside together in a single location or separated in different locations in various combinations. For instance, with reference to FIG. 1, it is contemplated that these components may reside, alone or in combination, in either of user device 120, target 130, host system 150, and/or phonetic scheme provider 140.

In one aspect, processor component 210 is configured to execute computer-readable instructions related to performing any of a plurality of functions. Processor component 210 can be a single processor or a plurality of processors which analyze and/or generate information utilized by memory component 220, input component 230, scheme component 240, generation component 250, output component 260, and/or translation component 270. Additionally or alternatively, processor component 210 may be configured to control one or more components of linguistic modification unit 200.

In another aspect, memory component 220 is coupled to processor component 210 and configured to store computer-readable instructions executed by processor component 210. Memory component 220 may also be configured to store any of a plurality of other types of data including data generated by any of input component 230, scheme component 240, generation component 250, output component 260, and/or translation component 270. Memory component 220 can be configured in a number of different configurations, including as random access memory, battery-backed memory, hard disk, magnetic tape, etc. Various features can also be implemented upon memory component 220, such as compression and automatic back up (e.g., use of a Redundant Array of Independent Drives configuration).

In yet another aspect, linguistic modification unit 200 includes input component 230 and output component 260, which are coupled to processor component 210 and configured to interface linguistic modification unit 200 with external entities. For instance, input component 230 may be configured to receive a user input that includes a linguistic expression and a selection of at least one target vernacular, whereas output component 260 may be configured to output an audible equivalent of the linguistic expression in the at least one target vernacular according to a corresponding phonetic scheme.

It is contemplated that input component 230 may be configured to receive linguistic expressions in any of various forms. For instance, input component 230 may be configured to receive linguistic expressions in a textual form via a short message service (SMS), multimedia messaging service (MMS), e-mail, or instant message. However, input component 230 may also be configured to receive linguistic expressions in an audio form. For instance, it is contemplated that input component 230 may be configured to receive a voice input (e.g., a user's voice), a recorded input (e.g., a recorded song), a link to an audio file, etc.

In another aspect, the input received via input component 230 may further include an output destination. Within such embodiment, output component 260 is configured to facilitate a transmission of the audible equivalent of the linguistic expression to the output destination. Here, it should be noted that such output destination can be any of a plurality of locations/devices (a mobile device, personal computer, e-mail account, social media site, etc.) configured to receive the audible equivalent in any of various forms (e.g., hyperlink, mp3, wave file, etc.). For example, within the context of a voice communication between mobile devices, input component 230 may be configured to receive a linguistic expression in an audio form (e.g., a callee's voice input), wherein output component 260 is configured to facilitate a real-time voice-to-voice transmission of the audible equivalent to the output destination.

As illustrated, linguistic modification unit 200 may also include scheme component 240 and generation component 250. Within such embodiment, scheme component 240 is configured to retrieve a phonetic scheme corresponding to the target vernacular selected by a user, whereas generation component 250 is configured to generate an audible equivalent of the linguistic expression in the target vernacular according to the phonetic scheme. Here, with respect to linguistic expressions received in audio form (e.g., a voice input), it should be appreciated that generation component 250 may be configured to generate various types of audible equivalents. For instance, generation component 250 may be configured to warp the audio form of the input according to the phonetic scheme, wherein aspects of the original input are preserved. Alternatively, generation component 250 may be configured to generate an audible equivalent of the input in a generic voice.

In a further aspect, it is contemplated that the phonetic scheme retrieved by scheme component 240 includes a set of accentuation rules associated with the vernacular selected by the user. Such set of accentuation rules may, for example, include a cadence uniquely associated with the target vernacular. Indeed, it is has been discovered that different vernaculars of the same language are often spoken with accents having vernacular-specific rhythms. Voice inflections in one vernacular, for example, may occur at a higher frequency than a different vernacular.

In another aspect, it is contemplated that scheme component 240 may be configured to retrieve any of a plurality of phonetic schemes respectively corresponding to a plurality of vernaculars. Namely, it is contemplated that each of a plurality of target vernaculars accessible to scheme component 240 has a corresponding phonetic scheme. Within such embodiment, generation component 250 can then be configured to generate audible equivalents according to any combination of phonetic schemes accessible to scheme component 240. For instance, generation component 250 may be configured to generate audible equivalents according to a mixed phonetic scheme, wherein the mixed phonetic scheme includes at least one unique aspect from each of a plurality of target vernaculars selected by a user (e.g., a hybrid Jamaican/Chinese accent). Alternatively, rather than mixing accents, generation component 250 may be configured to generate audible equivalents in which a first portion of the audible equivalent is generated according to a first target vernacular, and a second portion of the audible equivalent is generated according to a second target vernacular. For instance, an audible equivalent of a user's input may include a first sentence in a Jamaican accent, and a second sentence in a Chinese accent.

For some embodiments, it is contemplated translating a user's input into a foreign language may be desirable. Accordingly, linguistic modification unit 200 may also include translation component 270, which is configured to translate a user's linguistic expression from a native language to a foreign language. Moreover, within such embodiment, the target vernacular selected by a user is a vernacular associated with a foreign language. For example, an English-speaking user may wish to generate a Spanish equivalent of his/her voice input in a Puerto Rican accent. Here, before generating the Spanish equivalent, translation component 270 may be used to translate the user's voice input to Spanish. Once translated, generation component 250 can then generate the desired audible equivalent by applying a Puerto Rican phonetic scheme to a translated version of the user's voice input.

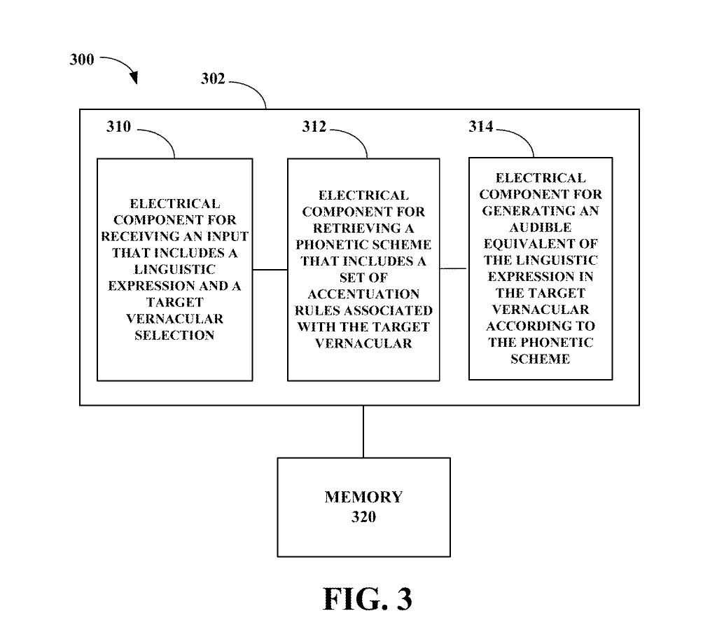

Turning to FIG. 3, illustrated is a system 300 that facilitates modifying a linguistic expression according to an embodiment. System 300 and/or instructions for implementing system 300 can reside within a computing device, for example. As depicted, system 300 includes functional blocks that can represent functions implemented by a processor using instructions and/or data from a computer readable storage medium. System 300 includes a logical grouping 302 of electrical components that can act in conjunction. As illustrated, logical grouping 302 can include an electrical component for receiving an input that includes a linguistic expression and a target vernacular selection 310. Furthermore, logical grouping 302 can include an electrical component for retrieving a phonetic scheme that includes a set of accentuation rules associated with the target vernacular 312. Logical grouping 302 can also include an electrical component for generating an audible equivalent of the linguistic expression in the target vernacular according to the phonetic scheme 314. As illustrated, system 300 can include a memory 320 configured to retain instructions for executing functions associated with electrical components 310, 312, and 314. While shown as being external to memory 320, it should again be appreciated that electrical components 310, 312, and 314 can exist within memory 320.

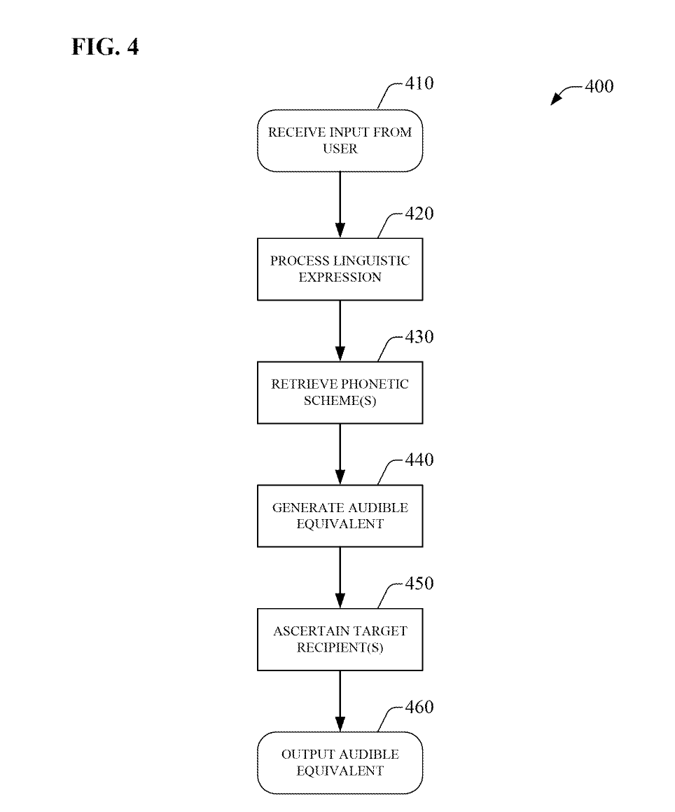

Referring next to FIG. 4, a flow chart illustrating an exemplary method for modifying linguistic expressions is provided. As illustrated, process 400 includes a series of acts that may be performed within a computer system (e.g., linguistic modification unit 200) according to an aspect of the subject specification. For instance, process 400 may be implemented by employing a processor to execute computer executable instructions stored on a computer readable storage medium to implement the series of acts. In another embodiment, a computer-readable storage medium comprising code for causing at least one computer to implement the acts of process 400 are contemplated.

In an aspect, process 400 begins with a user input being received at act 410. Here, as stated previously, it is contemplated that such input may include and/or identify a linguistic expression the user wishes to modify according to a desired target vernacular. For instance, a user may include the linguistic expression via a voice input, a textual input, an attached file, etc. However, a user may also simply reference the linguistic expression by, for example, providing a link to a text/audio file.

After receiving the user's input, process 400 continues to act 410 where the linguistic expression is processed. Since the linguistic expression may be received and/or identified in various ways, the processing of linguistic expressions may similarly vary. For instance, files may require downloading, text may require translating, audio may require dictating, etc.

After processing the linguistic expression at act 410, process 400 proceeds to act 430 where phonetic schemes corresponding to the user's target vernacular(s) are retrieved. An audible equivalent of the linguistic expression is then generated at act 440 according to the target vernacular(s). As stated previously, it is contemplated that a user may select multiple target vernaculars. Accordingly, the generating performed at act 440 may include reconciling how to generate the audible equivalent from multiple phonetic schemes. Such reconciliation may, for example, include merging the accentuation rules of each scheme to form a single hybrid phonetic scheme (e.g., a mixed California/Boston accent). Alternatively, the accentuation rules for each of the multiple phonetic schemes may be preserved and applied individually to different portions of the linguistic expression. For example, accentuation rules of a first scheme can be applied to one portion of the linguistic expression (e.g., applying rules of a California accent to a first verse of a song), whereas accentuation rules of a second scheme can be applied to another portion of the linguistic expression (e.g., applying rules of a Boston accent to a second verse of a song).

Once an audible equivalent is generated, process 400 proceeds to act 450 where target recipients of the audible equivalent are ascertained, and subsequently concludes at act 460 where the audible equivalent is output to those target recipients. Here, it should be appreciated that any of a plurality of target recipient types are contemplated. Moreover, instead of simply listening to the audible equivalent on a user's device, a user may wish to output the audible equivalent (and/or a reference to the audible equivalent, such as a link to a file) to other devices/locations. For example, it is contemplated that a link to the audible equivalent may be output to a social media site (e.g., via a wall post). The audible equivalent may also be included as an e-mail attachment, sent to a mobile device, etc.

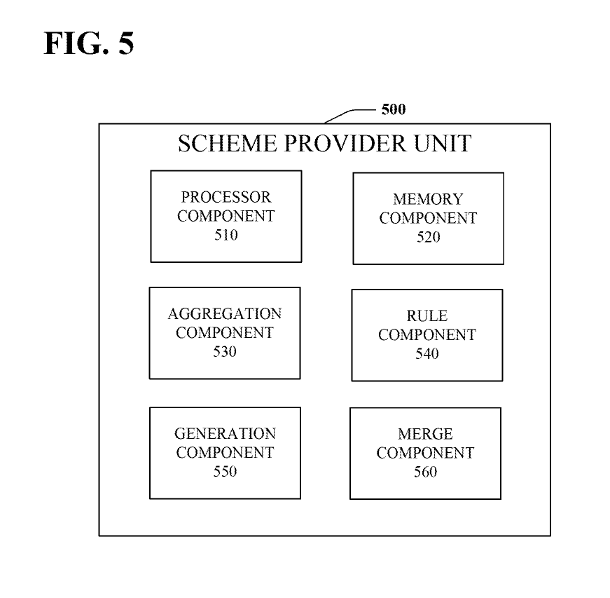

Referring next to FIG. 5, an exemplary scheme generation unit that facilitates generating phonetic schemes according to an embodiment is illustrated. As shown, scheme generation unit 500 may include processor component 510, memory component 520, aggregation component 530, rule component 540, generation component 550, and merge component 560.

Similar to processor component 210 in linguistic modification unit 200, processor component 510 is configured to execute computer-readable instructions related to performing any of a plurality of functions. Processor component 510 can be a single processor or a plurality of processors which analyze and/or generate information utilized by memory component 520, aggregation component 530, rule component 540, generation component 550, and/or merge component 560. Additionally or alternatively, processor component 510 may be configured to control one or more components of scheme generation unit 500.

In another aspect, memory component 520 is coupled to processor component 510 and configured to store computer-readable instructions executed by processor component 510. Memory component 520 may also be configured to store any of a plurality of other types of data including data generated by any of aggregation component 530, rule component 540, generation component 550, and/or merge component 560. Here, it should be noted that memory component 520 is analogous to memory component 220 in linguistic modification unit 200. Accordingly, it should be appreciated that any of the aforementioned features/configurations of memory component 220 are also applicable to memory component 520.

As illustrated, scheme generation unit 500 may also include aggregation component 530 and rule component 540. Within such embodiment, aggregation component 530 is configured to aggregate linguistic information corresponding to vernaculars, whereas rule component 540 is configured to analyze the linguistic information to ascertain accentuation rules associated with the vernaculars. Here, it should be appreciated that linguistic information aggregated by aggregation component 530 may include any of various types of linguistic information stored in any of a plurality of forms. For instance, in a particular embodiment, it is contemplated linguistic information may include audio samples associated with a corresponding vernacular. Within such embodiment, rule component 540 may then be configured to extrapolate accentuation rules from the audio samples (e.g., by identifying inflection patterns).

In another aspect, scheme generation unit 500 includes generation component 550, which is configured to generate a phonetic scheme corresponding to the linguistic information vernacular. Namely, generation component 550 is configured to generate phonetic schemes, wherein each phonetic scheme is unique to a particular vernacular and includes a corresponding set of accentuation rules associated with the particular vernacular. For instance, generation component 550 may be configured to maintain phonetic dictionaries respectively corresponding to various vernaculars (e.g., a phonetic dictionary indicating a pronunciation of “car” in a Bostonian accent).

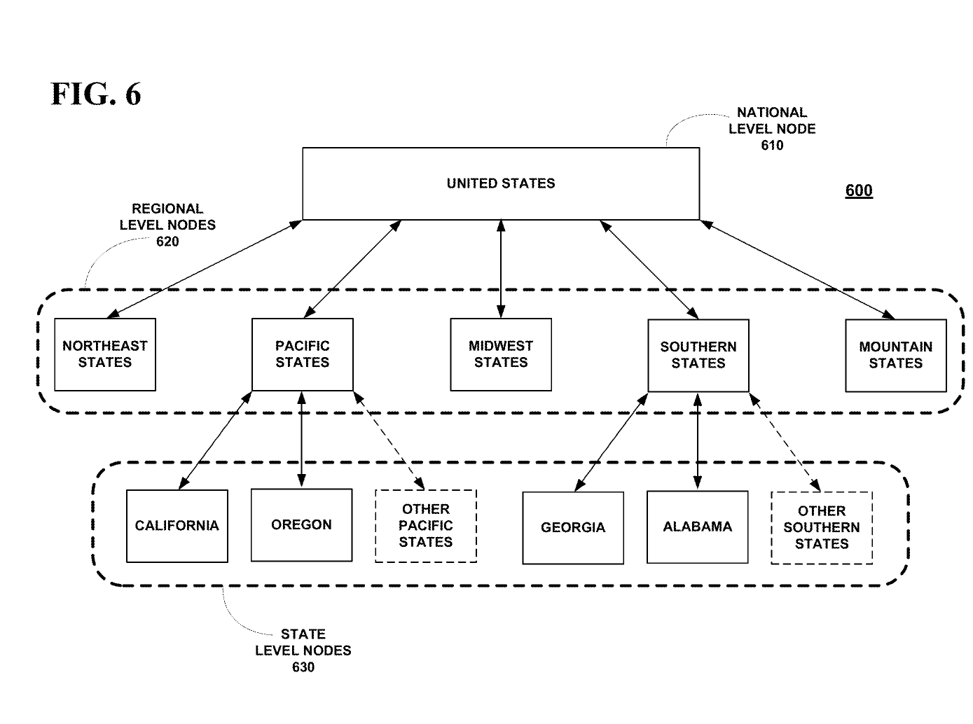

In another aspect, it is contemplated that users may wish to select vernaculars of variable granularities. For instance, whereas one user may select a “France” vernacular, another user may select a vernacular corresponding to a particular city in France (e.g., a “Lyon, France” vernacular). To facilitate generating phonetic schemes of variable granularities, scheme generation unit 500 may further include merge component 560. Within such embodiment, merge component 560 is configured to arrange phonetic schemes according to a hierarchy of nodes, such that an upper node corresponds to a “merged” phonetic scheme of lower node phonetic schemes. With reference to FIG. 6, for example, a hierarchy of nodes 600 may include national level node 610, regional level nodes 620, and state level nodes 630, as shown. For this particular example, it is contemplated that national level node 610 corresponds to a “United States” phonetic scheme, wherein such scheme merges the phonetic schemes included in regional level nodes 620 (i.e., “Northeast States,” “Pacific States,” “Midwest States,” “Southern States,” and “Mountain States”). Here, it is further contemplated that each of regional level nodes 620 may then similarly correspond to a merging of lower level nodes. For instance, as shown, a “Pacific States” phonetic scheme may merge phonetic schemes corresponding to “California,” “Oregon,” and “Other Pacific States,” whereas a “Southern States” phonetic scheme may merge phonetic schemes corresponding to “Georgia,” “Alabama,” and “Other Southern States.”

In yet another aspect, it is contemplated that users may wish to customize a merging of phonetic schemes. For instance, a user may wish to merge a “Mexican” accent of the English Language with a “Japanese” accent of the English Language. To facilitate creating such a mixed accent, merge component 560 may be further configured to merge distinct phonetic schemes. Moreover, merge component 560 may be configured to create a merged phonetic scheme, which includes aspects from any of a plurality of distinct phonetic schemes. For example, with respect to creating the aforementioned “Mexican/Japanese” accent, a “Mexico” phonetic scheme may be merged with a “Japan” phonetic scheme.

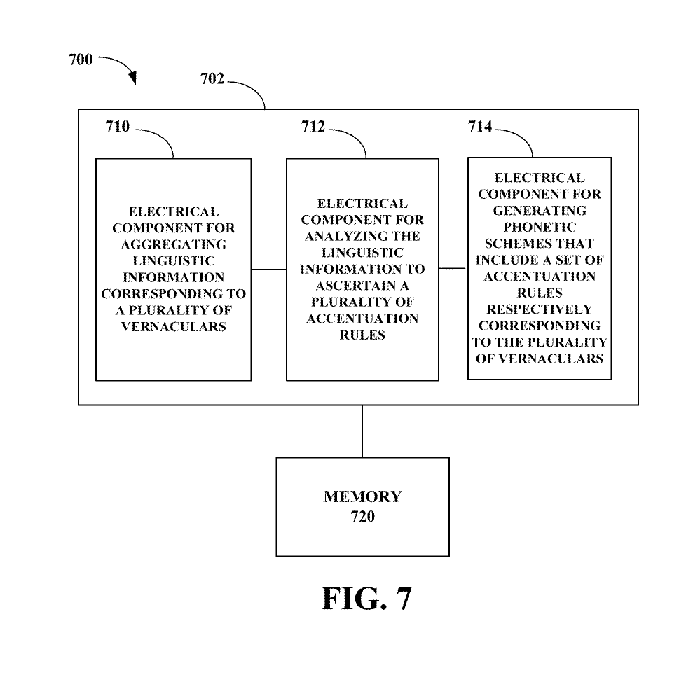

Referring next to FIG. 7, illustrated is an exemplary system 700 that facilitates generating phonetic schemes according to an embodiment. System 700 and/or instructions for implementing system 700 can also physically reside within a computing device, for instance, wherein system 700 includes functional blocks that can represent functions implemented by a processor using instructions and/or data from a computer readable storage medium. System 700 includes a logical grouping 702 of electrical components that can act in conjunction similar to logical grouping 302 in system 300. As illustrated, logical grouping 702 can include an electrical component for aggregating linguistic information corresponding to a plurality of vernaculars 710. Furthermore, logical grouping 702 can include an electrical component for analyzing the linguistic information to ascertain a plurality of accentuation rules 712. Logical grouping 702 can also include an electrical component for generating phonetic schemes that include a set of accentuation rules respectively corresponding to the plurality of vernaculars 714. As illustrated, system 700 can include a memory 720 configured to retain instructions for executing functions associated with electrical components 710, 712, and 714. While shown as being external to memory 720, it should again be appreciated that electrical components 710, 712, and 714 can exist within memory 720.

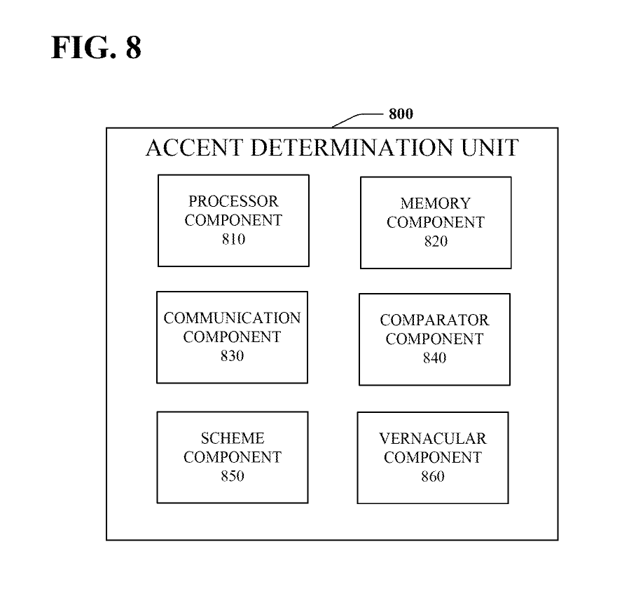

It is further contemplated that it may be desirable to determine and/or categorize the accent of a particular individual. For instance, because some accents are similar (e.g., an “English” accent and an “Australian” accent), it may be desirable to have a system and/or methodology for readily distinguishing between such accents and/or outputting a list of candidate accents (e.g., “sixty-five percent probable English accent, twenty percent probable Australian accent, five percent probable fish accent, etc.”). Referring next to FIG. 8, an exemplary accent determination unit that facilitates identifying such vernaculars according to an embodiment is illustrated. As shown, accent determination unit 800 may include processor component 810, memory component 820, communication component 830, comparator component 840, scheme component 850, and vernacular component 860.

Similar to processor component 210 and processor component 510 in linguistic modification unit 200 and scheme provider unit 500, respectively, processor component 810 is configured to execute computer-readable instructions related to performing any of a plurality of functions. Processor component 810 can be a single processor or a plurality of processors which analyze and/or generate information utilized by memory component 820, communication component 830, comparator component 840, scheme component 850, and/or vernacular component 860. Additionally or alternatively, processor component 810 may be configured to control one or more components of accent determination unit 800.

In another aspect, memory component 820 is coupled to processor component 810 and configured to store computer-readable instructions executed by processor component 810. Memory component 820 may also be configured to store any of a plurality of other types of data including data generated by any of communication component 830, comparator component 840, scheme component 850, and/or vernacular component 860. Here, it should be noted that memory component 820 is analogous to memory component 220 and memory component 520 in linguistic modification unit 200 and scheme provider unit 500, respectively. Accordingly, it should be appreciated that any of the aforementioned features/configurations of memory component 220 and memory component 520 are also applicable to memory component 820.

In yet another aspect, accent determination unit 800 includes communication component 830, which is coupled to processor component 810 and configured to interface accent determination unit 800 with external entities. For instance, communication component 830 may be configured to receive a voice sample, and subsequently output a likely vernacular of the voice sample identified by accent determination unit 800.

To facilitate identifying such vernacular, accent determination unit 800 may further include comparator component 840, scheme component 850, and vernacular component 860, as shown. Within such embodiment, comparator component 840 may be configured to compare aspects of a voice sample input with any of various phonetic schemes accessible to accent determination unit 800. Scheme component 850 may then be configured to select a “candidate” phonetic scheme according to a probability metric ascertained from comparator component 840, and vernacular component 860 may be configured to identify a “probable” vernacular for the voice sample corresponding to the candidate phonetic scheme.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

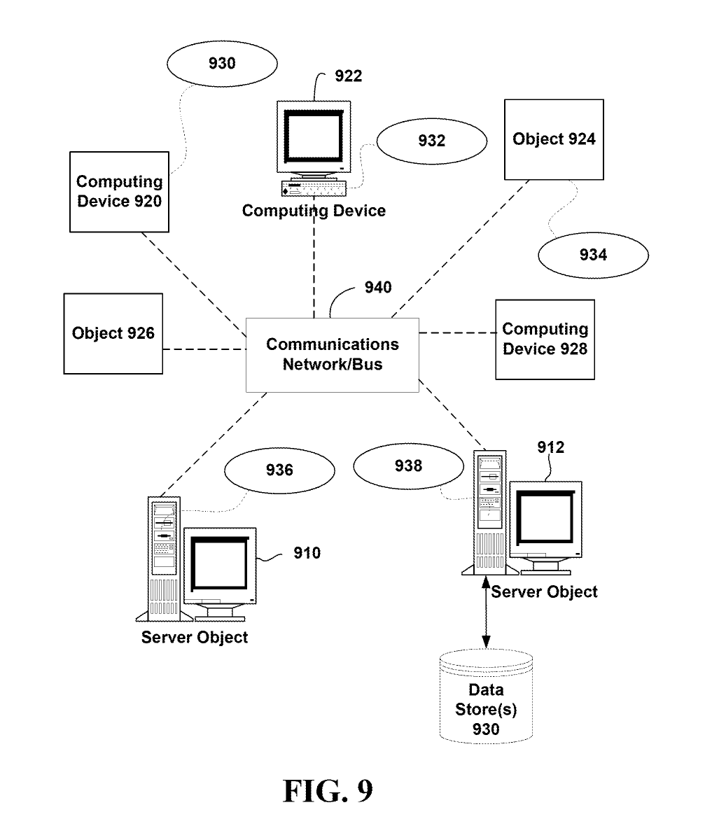

FIG. 9 provides a non-limiting schematic diagram of an exemplary networked or distributed computing environment. The distributed computing environment comprises computing objects or devices 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects or devices 910, 912, etc. and computing objects or devices 920, 922, 924, 926, 928, etc. may comprise different devices, such as PDAs (personal digital assistants), audio/video devices, mobile phones, MP3 players, laptops, etc.

Each computing object or device 910, 912, etc. and computing objects or devices 920, 922, 924, 926, 928, etc. can communicate with one or more other computing objects or devices 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object or device 910, 912, etc. or 920, 922, 924, 926, 928, etc. can also contain an application, such as applications 930, 932, 934, 936, 938, that might make use of an API (application programming interface), or other object, software, firmware and/or hardware, suitable for communication with or implementation of an infrastructure for information as a service from any platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects or devices 910, 912, etc. can be thought of as servers where computing objects or devices 910, 912, etc. provide data services, such as receiving data from computing objects or devices 920, 922, 924, 926, 928, etc., storing of data, processing of data, transmitting data to computing objects or devices 920, 922, 924, 926, 928, etc., although any computer can be considered a client, a server, or both, depending on the circumstances. Any of these computing devices may be processing data, or requesting services or tasks that may implicate an infrastructure for information as a service from any platform and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 940 is the Internet, for example, the computing objects or devices 910, 912, etc. can be Web servers with which the computing objects or devices 920, 922, 924, 926, 928, etc. communicate via any of a number of known protocols, such as HTTP. As mentioned, computing objects or devices 910, 912, etc. may also serve as computing objects or devices 920, 922, 924, 926, 928, etc., or vice versa, as may be characteristic of a distributed computing environment.

### Exemplary Computing Device

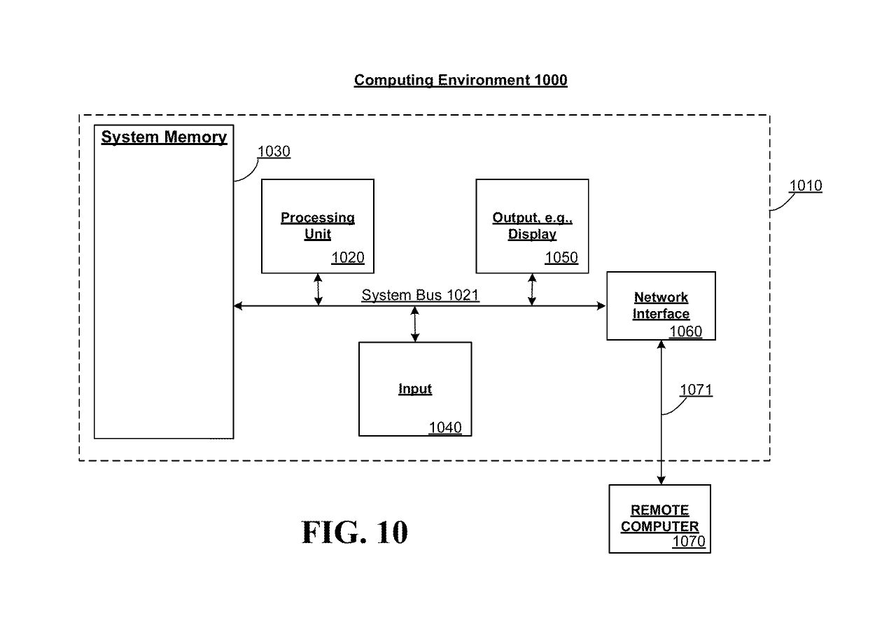

As mentioned, several of the aforementioned embodiments apply to any device wherein it may be desirable to utilize a computing device to modify a linguistic expression according to the aspects disclosed herein. It is understood, therefore, that handheld, portable and other computing devices and computing objects of all kinds are contemplated for use in connection with the various embodiments described herein, i.e., anywhere that a device may provide some functionality in connection with modifying a linguistic expression. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. The computing environment 1000 is not to be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and networks, the underlying concepts may be applied to any network system and any computing device or system in which it is desirable to publish, build applications for or consume data in connection with modifying a linguistic expression.

There are multiple ways of implementing one or more of the embodiments described herein, e.g., an appropriate API, tool kit, driver code, operating system, control, standalone or downloadable software object, etc. which enables applications and services to use the infrastructure for information as a service from any platform. Embodiments may be contemplated from the standpoint of an API (or other software object), as well as from a software or hardware object that facilitates provision of an infrastructure for information as a service from any platform in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A computer-readable storage medium, comprising:
computer-readable instructions, the computer-readable instructions including instructions for causing at least one processor to perform the following acts:
receiving an input, wherein the input includes a linguistic expression and a selection of at least one target vernacular;
retrieving a phonetic scheme corresponding to the at least one target vernacular, wherein the phonetic scheme includes a set of accentuation rules associated with the at least one target vernacular; and
generating an audible equivalent of the linguistic expression in the at least one target vernacular, wherein the generating is performed according to the phonetic scheme.

2. The computer-readable storage medium according to claim 1, wherein the input includes the linguistic expression in an audio form.

3. The computer-readable storage medium according to claim 2, wherein the generating comprises warping the audio form of the input according to the phonetic scheme.

4. The computer-readable storage medium according to claim 1, wherein the input includes the linguistic expression in a textual form.

5. The computer-readable storage medium according to claim 1, wherein the set of accentuation rules includes a cadence associated with the at least one target vernacular.

6. The computer-readable storage medium according to claim 1, wherein the at least one target vernacular is a plurality of target vernaculars, and wherein each of the plurality of target vernaculars has a corresponding phonetic scheme.

7. The computer-readable storage medium according to claim 6, wherein the generating is performed according to a mixed phonetic scheme, and wherein the mixed phonetic scheme includes at least one unique aspect from each of the plurality of target vernaculars.

8. The computer-readable storage medium according to claim 6, wherein the generating comprises generating a first portion of the audible equivalent according to a first of the plurality of target vernaculars, and wherein the generating further comprises generating a second portion of the audible equivalent according to a second of the plurality of target vernaculars.

9. A system, comprising:
a processor; and
a memory component communicatively coupled to the processor, the memory component having stored therein computer-executable instructions that when executed by the processor cause the processor to implement:
an input component configured to receive an input, wherein the input includes a linguistic expression and a selection of at least one target vernacular;
a scheme component configured to retrieve a phonetic scheme corresponding to the at least one target vernacular, wherein the phonetic scheme includes a set of accentuation rules associated with the at least one target vernacular;
a generation component configured to generate an audible equivalent of the linguistic expression in the at least one target vernacular, wherein the generation component is further configured to generate the audible equivalent according to the phonetic scheme; and
an output component configured to output the audible equivalent.

10. The system of claim 9, wherein the input component is configured to receive the linguistic expression in a textual form via one of an SMS, an MMS, an e-mail, or an instant message.

11. The system of claim 9, wherein the input further includes an output destination, and wherein the output component is configured to facilitate a transmission of the audible equivalent to the output destination.

12. The system of claim 11, wherein the input component is configured to receive the linguistic expression in an audio form, and wherein the output component is configured to facilitate a real-time voice-to-voice transmission of the audible equivalent to the output destination.

13. The system of claim 9, wherein the retrieval component is configured to retrieve any of a plurality of phonetic schemes respectively corresponding to a plurality of vernaculars.

14. The system of claim 9, further comprising a translation component configured to translate the linguistic expression from a native language to a foreign language, wherein the at least one target vernacular is a vernacular associated with the foreign language.

15. A method comprising:
employing a processor to execute computer executable instructions stored on a computer readable storage medium to implement the following acts:
aggregating linguistic information corresponding to a plurality of vernaculars;
analyzing the linguistic information to ascertain a plurality of accentuation rules; and
generating a plurality of phonetic schemes respectively corresponding to the plurality of vernaculars, wherein each of the plurality of phonetic schemes is unique to a particular vernacular and includes a corresponding set of accentuation rules associated with the particular vernacular.

16. The method according to claim 15, wherein the generating further comprises maintaining a plurality of phonetic dictionaries respectively corresponding to the plurality of vernaculars.

17. The method according to claim 15, wherein the linguistic information includes at least one audio sample associated with a corresponding vernacular, and wherein the analyzing comprises extrapolating at least one accentuation rule from the at least one audio sample.

18. The method according to claim 15, further comprising:
comparing aspects of a voice sample to a plurality of stored phonetic schemes;
selecting a candidate phonetic scheme from the plurality of stored phonetic schemes, wherein the candidate phonetic scheme is selected according to a probability metric ascertained from the comparing; and
identifying a probable vernacular associated with the voice sample, wherein the probable vernacular corresponds to the candidate phonetic scheme.

19. The method according to claim 15, further comprising arranging the plurality of phonetic schemes according to a hierarchy of nodes, wherein an upper node corresponds to a merged phonetic scheme of lower node phonetic schemes.

20. The method according to claim 15, further comprising merging at least two distinct phonetic schemes, wherein the generating comprises generating a merged phonetic scheme that includes aspects from each of the at least two distinct phonetic schemes.
